(19) United States
(12) Patent Application Publication
(10) Pub. No.: US 2020/0163181 A1
(43) Pub. Date: May 21, 2020

(54) Optimization Of Space Utilization

(71) Applicant: Eaton Intelligent Power Limited, Dublin 4 (IE)

(72) Inventors: Akash Paresh Shah, Atlanta, GA (US); Ryan Lamon Cunningham, Fayetteville, GA (US); Harold Dean Allen, III, Senoia, GA (US); Paul Boudreau, Lawrenceville, GA (US); Jessica Jiang, Marietta, GA (US)

(21) Appl. No.: 16/689,757

(22) Filed: Nov. 20, 2019

Related U.S. Application Data
(60) Provisional application No. 62/770,118, filed on Nov. 20, 2018.

(51) Int. Cl. H05B 37/02; G08B 5/36; G06Q 10/02; G06Q 10/10; G06K 9/00

(52) U.S. Cl. CPC H05B 37/0281; G08B 5/36; G06K 9/00771; G06Q 10/1095; G06Q 10/02

(57) ABSTRACT

A non-transitory computer-readable medium of a reservation controller contains instructions executable by a processor. The instructions include receiving a user request for a requested space, where the user request includes a time slot for a use of the requested space. The instructions include identifying unoccupied spaces based on current status information from multiple occupancy sensors in response to determining that the time slot is within a threshold period of time from a current time. The unoccupied spaces are one or more of multiple spaces that are currently unoccupied. The instructions also include identifying available spaces from among the unoccupied spaces and reserving a matching space from among the available spaces.

### CROSS REFERENCE TO RELATED APPLICATIONS

The present application claims priority under 35 U.S.C. Section 119(e) to U.S. Provisional Patent Application No. 62/770,118, filed Nov. 20, 2018 and titled “Optimization Of Space Utilization,” the entire content of which is incorporated herein by reference.

### TECHNICAL FIELD

The present disclosure relates generally to space reservation, and more particularly to a location-based space reservation system.

### BACKGROUND

When a person needs a space, such as a conference room, a hoteling desk, etc., for current use, a person often has to walk around looking for an available space that has one or more pieces of needed equipment, such as a projector, etc. Such a process may be time consuming and may be less than ideal in finding a space that has a desired equipment. Further, in a typical space reservation process, a user often reserves a space that the user has tacit knowledge of, for example, based on prior use of the space, such as a room, a hoteling desk, etc. For example, a person that has attended a meeting in a particular room may reserve the same room in the future although there may be other rooms that are better suited for the person's needs. As another example, a person may reserve a room for a meeting because the person had used or seen equipment such as a projector, a white board, a podium, etc. in the room. However, in some cases, a person may find other people are using the reserved room upon arrival at the reserved space. The person may also find that one or more pieces of equipment are unavailable in the room and/or that the room is inconveniently located for attendees. Thus, a reservation system that allows a user to define requirements for space and equipment and make a reservation based on information related to availability of equipment and/or locations of attendees may be desirable.

### SUMMARY

The present disclosure relates generally to space reservation, and more particularly to a location-based space reservation system. In an example embodiment, a non-transitory computer-readable medium of a reservation controller contains instructions executable by a processor. The instructions include receiving a user request for a requested space, where the user request includes a time slot for a use of the requested space. The instructions include identifying unoccupied spaces based on current status information from multiple occupancy sensors in response to determining that the time slot is within a threshold period of time from a current time. The unoccupied spaces are one or more of multiple spaces that are currently unoccupied. The instructions also include identifying available spaces from among the unoccupied spaces and reserving a matching space from among the available spaces.

In another example embodiment, a non-transitory computer-readable medium of a reservation controller contains instructions executable by a processor. The instructions include reserving a space for use during a time slot and determining, at a threshold time before the time slot, if the space is occupied based on current status information received from an occupancy sensor located at the space. The instructions further include in response to determining that the space is occupied, providing a notification through the lighting fixture located at the space that the space is reserved.

In another example embodiment, a system of space reservation and notification includes a reservation controller configured to reserve a space for a time slot and a lighting fixture located at the spaced. The system further includes an occupancy sensor located at the space, where the reservation controller is configured to determine, at a threshold time before the time slot, if the space is occupied based on current status information received from an occupancy sensor located at the space. The reservation controller is further configured to provide, in response to determining that the space is occupied, a notification through the lighting fixture located that the space is reserved.

These and other aspects, objects, features, and embodiments will be apparent from the following description and the claims.

### BRIEF DESCRIPTION OF THE FIGURES

Reference will now be made to the accompanying drawings, which are not necessarily drawn to scale, and wherein:

FIG. 1 illustrates a space reservation system according to an example embodiment;

FIG. 2 illustrates a method of reserving a space based on a time slot according to an example embodiment;

FIG. 3 illustrates a method of reserving a space based on a time slot according to another example embodiment;

FIG. 4 illustrates a method of reserving a space based on locations of attendees according to an example embodiment;

FIG. 5 illustrates a method of reserving a space based on locations of attendees according to another example embodiment;

FIG. 6 illustrates a method of space reserving and notification according to an example embodiment; and

FIG. 7 illustrates a method of space reserving and space preparation according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different figures designate like or corresponding but not necessarily identical elements.

### DETAILED DESCRIPTION OF THE EXAMPLE EMBODIMENTS

In the following paragraphs, example embodiments will be described in further detail with reference to the figures. In the description, well-known components, methods, and/or processing techniques are omitted or briefly described. Furthermore, reference to various feature(s) of the embodiments is not to suggest that all embodiments must include the referenced feature(s).

In some example embodiments, a reservation system for spaces, such as conference rooms, cubicles, hoteling desks, hospital patient rooms, hospital procedure rooms, etc., may be used to reserve a space based on a user's requirements. In some cases, information from a database of existing information (e.g., office location of employees, locations of room size, space with built-in equipment, etc.) and/or dynamic information (e.g., current locations of personnel, current locations of equipment, occupancy status of a room, etc.) may be used to make reservations and/or provide notifications. For example, real-time Locating Systems (RTLS) sensors and occupancy sensors that are standalone or integrated into lighting fixtures and other lighting devices may be used to provide current occupancy and location information of equipment and people.

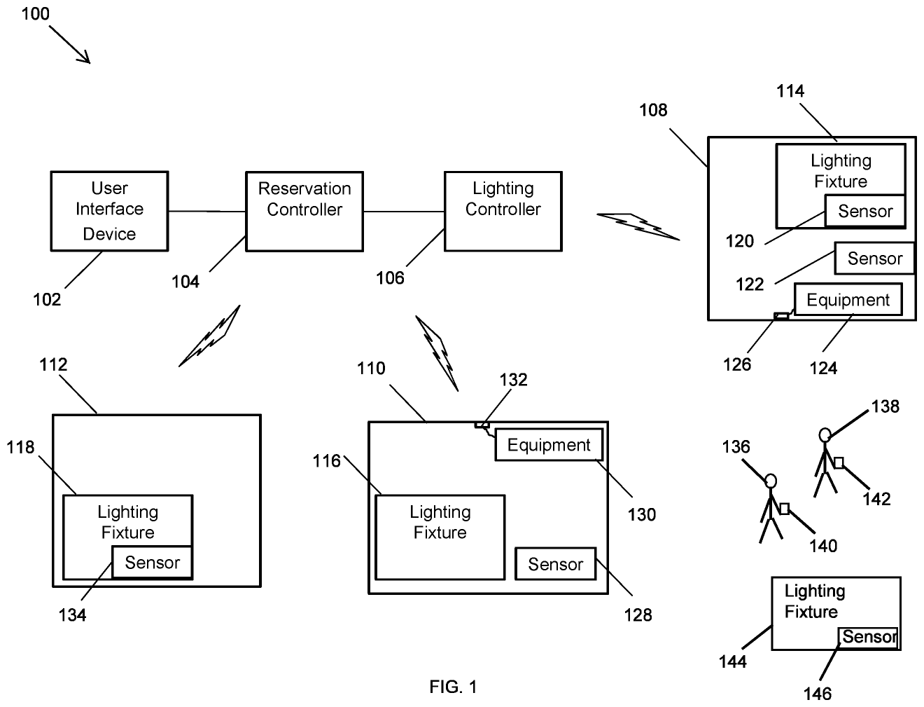

Turning now to the figures, particular example embodiments are described. FIG. 1 illustrates a space reservation system 100 according to an example embodiment. In some example embodiments, the system 100 includes a user interface device 102, a reservation controller 104, and a lighting controller 106. The user interface device 102 may be a mobile device (e.g., a mobile phone, a tablet, or a laptop), a desktop, or another device capable of displaying reservation related information to a user and receiving input from the user. To illustrate, the user interface device 102 may provide a user interface for a user to request a space among available spaces 108, 110, 112. The spaces 108-112 may each be a room, a hoteling desk, a cubicle, etc. In some example embodiments, each space 108-112 may be a conference room, a hospital patient room, a medical procedure room (e.g., a surgical operation room), etc.

In some example embodiments, a lighting fixture 114 that includes an integrated sensor 120 may be located at the space 108. A sensor 122 and equipment 124 may also be located at the space 108. The sensors 120, 122 may each include an occupancy sensor (e.g., a PIR motion sensor, BLE beacon sensor, etc.) and/or an RTLS sensor (e.g., a BLE beacon sensor, Wi-Fi based sensor, etc.). The sensors 120, 122 may be positioned to detect occupancy of the space 108 and/or to receive RTLS information (e.g., BLE beacon) from RTLS devices located in the space 108. The sensors 120, 122 may each transmit sensing status information (e.g., information indicating whether an occupant is detected and/or information indicating whether equipment is detected) to the reservation controller 104 and/or the lighting controller 106.

In some example embodiments, the equipment 124 may include a portable projector, a laser pointer, a portable white board, a medical device (e.g., dialysis machine, breathing equipment, surgical equipment such as robotic arm, particular lighting fixture, a camera, etc.), etc. For example, the equipment 124 may be a projector that is plugged into a power receptacle 126. The receptacle 126 may be controllable, for example, by the reservation controller 104 and/or the lighting controller 106 to turn on and off power at the receptacle 126.

In some example embodiments, a lighting fixture 116 may be located at the space 110. A sensor 128 and equipment 130 may also be located at the space 110. The sensor 128 may include an occupancy sensor (e.g., a PIR motion sensor, BLE beacon sensor, etc.) and/or an RTLS sensor (e.g., a BLE beacon sensor, Wi-Fi based sensor, etc.). The sensor 128 may be positioned to detect occupancy of the space 110 and/or to receive RTLS information (e.g., BLE beacon) from RTLS devices located in the space 110. The sensor 128 may transmit sensing status information (e.g., information indicating whether an occupant is detected by the sensor 128 and/or information indicating whether an equipment is detected by the sensor 128) to the reservation controller 104 and/or the lighting controller 106.

In some example embodiments, the equipment 130 may include a portable projector, a laser pointer, a portable white board, a medical device, etc. For example, the equipment 130 may be a projector that is plugged into a power receptacle 132. The receptacle 132 may be controllable, for example, by the reservation controller 104 and/or the lighting controller 106 to turn on and off power at the receptacle 132.

In some example embodiments, a lighting fixture 118 that includes an integrated sensor 134 may be located at the space 112. The sensor 134 may include an occupancy sensor (e.g., a PIR motion sensor, BLE beacon sensor, etc.) and/or an RTLS sensor (e.g., a BLE beacon sensor, Wi-Fi based sensor, etc.). The sensor 134 may be positioned to detect occupancy of the space 112 and/or to receive RTLS information (e.g., BLE beacon) from RTLS devices located in the space 112. The sensor 134 may transmit sensing status information (e.g., information indicating whether an occupant is detected by the sensor 134 and/or information indicating whether an equipment is detected by the sensor 134) to the reservation controller 104 and/or the lighting controller 106.

In some example embodiments, the equipment 124 may include a portable projector, a laser pointer, a portable white board, a medical device, etc. For example, the equipment 124 may be a projector that is plugged into a power receptacle 126. The receptacle 126 may be controllable, for example, by the reservation controller 104 and/or the lighting controller 106 to turn on and off power at the receptacle 126.

In some example embodiments, a lighting fixture 144 that includes an integrated sensor 146 may be located in an area outside of the spaces 108-112. The sensor 146 may include an occupancy sensor (e.g., a PIR motion sensor, BLE beacon sensor, etc.) and/or an RTLS sensor (e.g., a BLE beacon sensor, Wi-Fi based sensor, etc.). The sensor 146 may transmit sensing status information (e.g., information indicating whether a motion is detected by the sensor 146 and/or information indicating whether an equipment is detected by the sensor 146) to the reservation controller 104 and/or the lighting controller 106. To illustrate, the sensor 146 may detect BLE beacons from the RTLS devices 140, 142 that are carried by individuals 136, 138. For example, the RTLS devices 140 and 142 may be employee badges, mobile devices, etc. and may be uniquely assigned to the particular individuals 136 and 138, respectively.

In some example embodiments, the user interface device 102 may be communicably coupled to the reservation controller 104. For example, the user interface device 102 may communicate with the reservation controller 104 wirelessly and/or via a wired connection. To illustrate, the reservation controller 104 may process user inputs provided via the user interface device 102 and provide reservation and other information to the user interface device 102 for displaying to the user. For example, the reservation controller 104 may include a control device (e.g., a processor device that includes a microcontroller that executes software code stored in a memory device such a flash memory), communication modules, database servers, etc. that are used in making reservations, providing notifications, and performing other functions of the reservation controller 104. To illustrate, the microcontroller of the reservation controller 104 may control other components to perform operations described herein with respect to the reservation controller 104. The reservation controller 104 may communicate with sensors, such as the sensors 120, 122, 128, 134, and 146, directly and/or through the lighting controller 106.

In some example embodiments, the lighting controller 106 may control operations of lighting fixtures and/or for communication with lighting fixtures, such as the lighting fixtures 114, 116, 118, 144. For example, the lighting controller 106 may control powering on and off, dim levels, color temperature of lights provided by lighting fixtures 114, 116, 118, 144. The lighting controller 106 may also communicate with the reservation controller 104 wirelessly or via a wired connection, and the reservation controller 104 may provide information or instructions to the lighting controller 106 for controlling lighting fixtures 114, 116, 118, 144. The lighting controller 106 may also be used to communicate with and/or control operations of sensors 120, 122, 128, 134, and 146. For example, the lighting controller 106 may receive occupancy and/or location information from sensors, such as the sensors 120, 122, 128, 134, and 146, and provide the information to the reservation controller 104.

In some example embodiments, the lighting fixtures, standalone and integrated sensors, and other lighting devices, such as the power receptacles, inside and outside the spaces 108-112 may communicate wirelessly or via wired connections with the reservation controller 104 and/or the lighting controller 106. The reservation controller 104 may receive a user request via the user interface device 102 and reserve a space, such as one of the spaces 108-112, based on requirements provided by the user, information stored in or retrieved by the reservation controller 104 (e.g., room sizes, fixed equipment location, assigned locations of individuals such as office location), and/or occupancy and location information received from the sensors. The reservation controller 104 may provide instructions for adjustment of lighting at the reserved space at the reserved time slot. The reservation controller 104 may also provide notification to a user and others, such as attendees, occupants of a reserved space, etc.

In some example embodiments, a user would request, through the user interface device 102, the use of a room for immediate use or at a future time slot. The user interface device 102 may forward the request to the reservation controller 104. If the request is for immediate use or for use within a short period of time (e.g., 30 minutes), the reservation controller 104 may poll all occupancy sensors, such as some or all of the sensors 120, 122, 128, 134, and 146, directly or through the lighting controller 106, to identify rooms, such as the spaces 108-112, that are unoccupied. After identifying rooms that are unoccupied, the reservation controller 104 may determine whether the unoccupied rooms are scheduled for use during the time slot requested by the user. Alternatively, at the same time that the reservation controller 104 checks current occupancy, the reservation controller 104 may check whether all rooms, such as the spaces 108-112 and other spaces, are scheduled for use during the time slot. If the user request is for a room at a future time (e.g., more than 30 minutes from current time), the reservation controller 104 may not check the occupancy status of rooms by polling sensors. The list of available rooms (i.e., unreserved and, if for immediate or near future use, unoccupied rooms) are compared by the reservation controller 104 to the requested room, and the closest available option is provided to the user, for example, via the user interface device 102. The closest available option may be a room that has the most specifications (e.g., room size, fixed equipment, portable equipment, etc.) that match the requirements of the request by the user.

In some example embodiments, the user may request, through the user interface device 102, the use of a room for immediate use (e.g., 9:00 a.m. to 10:00 a.m., where the current time is 8:55 a.m. or 9:00 a.m.) or at a future time slot (e.g., 11:00 a.m. to 12:00 p.m.). The user may also provide a list of attendees. The user interface device 102 may forward the request to the reservation controller 104. If the request is for immediate use or for use within a short period of time (e.g., 10 minutes), the reservation controller 104 may poll all RTLS sensors, such as some or all of the sensors 120, 122, 128, 134, and 146, directly or through the lighting controller 106, to identify locations of the attendees, such as the individuals 136, 138. For example, BLE beacons that are transmitted by the RTLS devices 140, 142 and received by the sensor 146 may be used to determine the general location of the individuals 136, 138 based on the known location of the sensor 146 or of the lighting fixture 144. If the user request is for a room at a future time (e.g., more than 30 minutes from current time), the reservation controller 104 may not check the locations of attendees using the sensors. Instead, the reservation controller 104 may retrieve location information from a database of designated locations of individuals (e.g., office locations) for use as the locations of attendees. Whether the locations of attendees is determined based on information from RTLS sensors or a designated location database, the reservation controller 104 checks availability of rooms at the requested time slot, for example, as described above, and considers other requirements of the user along with the locations of the available spaces relative to the locations of attendees to select a room for reservation so that the selected room is located conveniently as much as possible. For example, the reservation controller 104 may select the space 108 after determining that the individuals 136, 138 are located near the space 108 based on a database of space locations and locations of the individuals 136, 138 as determined based on location information provided by the sensor 146 based on BLE beacons from the RTLS devices 140, 142.

In some example embodiments, the user may request, through the user interface device 102, the use of a room for immediate use (e.g., 9:00 a.m. to 10:00 a.m., where the current time is 8:50 a.m. or 8:59 a.m.) or at a future time slot (e.g., 1:00 p.m. to 2:00 p.m.). The user may also submit required fixed/static equipment, such as a telephone, a monitor, etc., other requirements (e.g., number of attendees or capacity, etc.) and required portable equipment, such as a projector, a podium, a whiteboard, etc. The user interface device 102 may forward the request to the reservation controller 104. The reservation controller 104 may identify rooms that have the requested fixed equipment and that meet the sizes or capacity (e.g., seats) and other requirements based on information retrieved from a database of such information. The reservation controller 104 may also determine locations of requested portable equipment (e.g., the equipment 124, 130) based on information from RTLS sensors, such as the sensors 120, 122, 128. For example, the equipment 124, 130 may regularly transmit BLE beacons that are received by the sensors 122, 128, respectively. Because the BLE beacons may be unique to a particular equipment or equipment type, the equipment 124, 130 may be identified by the sensors 122, 128, the reservation controller 104, or the lighting control device 106. As described above, the locations of the sensors 122, 128 (or associated lighting fixtures, if any), which are known, may be used as the locations of the equipment 124, 130, respectively. Along with requirements, such as availability during requested time slot, size/capacity, and fixed equipment, the reservation controller 104 may identify and reserve a room (e.g., one of the spaces 108-112) that meets more of the user requirements than other rooms. In some alternative embodiments, the user may simply request for a location of a specific equipment, and the reservation controller 104 may identify the locations of the equipment based on location information from a database or from RTLS sensors and provide the information to the user, for example, via the user interface device 102.

In some example embodiments, after a room (e.g., one of the spaces 108-112) is reserved, the reservation controller 104 may perform some operations related to the reserved room. For example, the reservation controller 104 may poll the RTLS sensor(s) and verify that the requested equipment is located in the room. To illustrate, if the reserved room is the space 108, the reservation controller 104 may poll, for example, the sensor 122 to verify that the equipment 124 (e.g., a portable projector, podium, etc.), requested by the user, is located in the space 108. If the equipment 124 is no longer in the space 108, the reservation controller 104 may notify the user, for example, via email, SMS, etc. that the equipment 124 is not available in the space 108. The reservation controller 104 may also provide location of the equipment 124 or replacement equipment (e.g., the equipment 130) after locating the equipment based on information from RTLS sensors (e.g., the sensor 128). The reservation controller 104 may also verify that the room is unoccupied, for example, a few minutes (e.g., 3 minutes) prior to the reserved time slot based on occupancy information from sensors. To illustrate, the reservation controller 104 may also verify that the space 108 is unoccupied based on information from, for example, the sensor 120. If the reservation controller 104 determines that, for example, the space 108 that has been reserved is occupied a few minutes before the reserved time slot, the reservation controller 104, directly or through the lighting controller 106, may provide notification to occupants of the space 108. For example, the reservation controller 104 may cause the lighting fixture 114 to flash a light or otherwise provide a visual or audio notification that indicates that the space 108 is reserved for use shortly.

In some example embodiments, the reservation controller 104, directly or through the lighting controller 106, may control one or more lighting fixtures to adjust the lighting of the reserved room (e.g., the space 108), such as dim level, color temperature, etc., at the beginning of the reserved time slot. For example, the reservation controller 104 may control the lighting fixture 114 to adjust the light provided by the lighting fixture 114. The reservation controller 104, directly or through the lighting controller 106, may also turn on power at the receptacle 126 so that the equipment 124 (e.g., a projector) may be powered at the beginning of the reserved time slot.

Although a single user interface device 102 is shown, in alternative embodiments, the system 100 may include multiple user interface devices. The user interface device 102 may include or may operate with one or more of email integration, Google Calendar, Outlook, SMS (text), a reservation GUI (graphic user interface), etc. to receive user request for a space. In some alternative embodiments, the system 100 may operate with more or fewer pieces of equipment than shown. In some alternative embodiments, the system 100 may operate with more or fewer sensors, lighting fixtures, spaces, etc. than shown without departing from the scope of this disclosure. In some example embodiments, instead of polling sensors, the reservation controller 104 may periodically (e.g., every 5 minutes) receive information from the sensors and use the latest available received information to determine the locations of individuals and equipment and/or occupancy status of a space.

In general, space capacity (e.g., number of attendees), fixed equipment, portable equipment, particular attendees, time slot for use, and preferred general location, and a number other pieces of information or requirements may be provided to the user interface device 102 and may be considered by the reservation controller 104 in identifying an appropriate space (e.g., conference room, hoteling desk, a patient room, etc.) based meeting particular requirements (e.g., unreserved during a desired time slot) and/or meeting more requirements than other spaces. In some example embodiments, one or more components of the system 100 may be integrated or omitted without departing from the scope of this disclosure. For example, the and the lighting controller 106 may be integrated into the reservation controller 104.

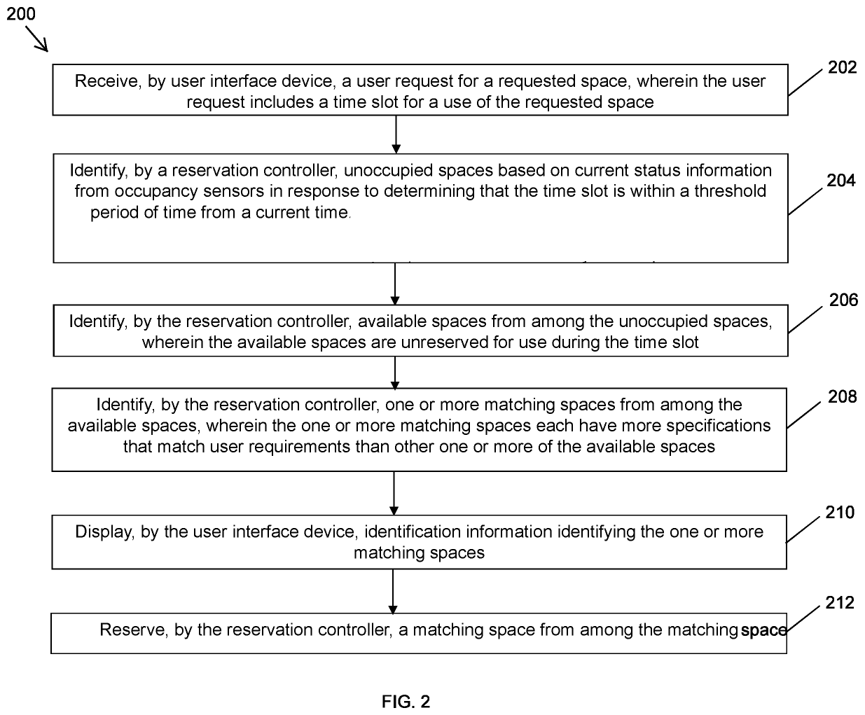

FIG. 2 illustrates a method 200 of reserving a space based on a time slot according to an example embodiment. Referring to FIGS. 1 and 2, in some example embodiments, the method 200 includes, at step 202, receiving, by user interface device 102, a user request for a requested space, where the user request includes a time slot for a use of the requested space. In some example embodiments, the user request includes number of attendees, identification of attendees, fixed and portable equipment needs, capacity, lighting preferences, etc.

In some example embodiments, at step 204, the method 200 may include identifying, by a reservation controller 104, unoccupied spaces based on current status information from occupancy sensors (e.g., sensors 120, 122, 128, 134, and 146) in response to determining that the time slot is within a threshold period of time (e.g., 5 minutes) from a current time. As illustrated in FIG. 1, one or more of the occupancy sensors (e.g., sensors 120, 134, and 146) are integrated in lighting fixtures (e.g., lighting fixtures 14, 118, 144) located at multiple spaces (e.g., the spaces 108, 112). The unoccupied spaces (e.g., the spaces 108, 112) are one or more of the multiple spaces (e.g., the spaces 108, 110, 112) that are currently unoccupied.

In some example embodiments, at step 206, the method 200 may include identifying, by the reservation controller 104, available spaces from among the unoccupied spaces, where the available spaces are unreserved for use during the time slot. At step 208, the method 200 may include identifying, by the reservation controller 104, one or more matching spaces from among the available spaces, where the one or more matching spaces each have more specifications that match user requirements than remaining one or more of the available spaces. For example, the specifications may include room size or capacity, required or desired fixed equipment, required or desired portable equipment, etc.

In some example embodiments, at step 210, method 200 may include displaying, by the user interface device 102, identification information identifying the one or more matching spaces, for example, at the user interface device 102. At step 212, method 200 may include reserving, by the reservation controller, a matching space from among the matching spaces. For example, the reservation controller 104 may reserve the matching space (e.g., the space 116) in response to a user input provided via the user interface device 102 requesting or affirming the reservation of the matching space. In some example embodiments, the wayfinding guide may be provided to the user and/or other attendees (e.g., by continually sending a route from the current locations of the user and/or other attendees as determined by RTLS sensors) to the matched/reserved location.

In some alternative embodiments, the steps of the method 200 may be performed in a different order than described above without departing from the scope of this disclosure. In some alternative embodiments, the method 200 may include more steps than described above without departing from the scope of this disclosure. For example, one or more steps of the method 200 may be combined with one or more steps of the other methods described herein.

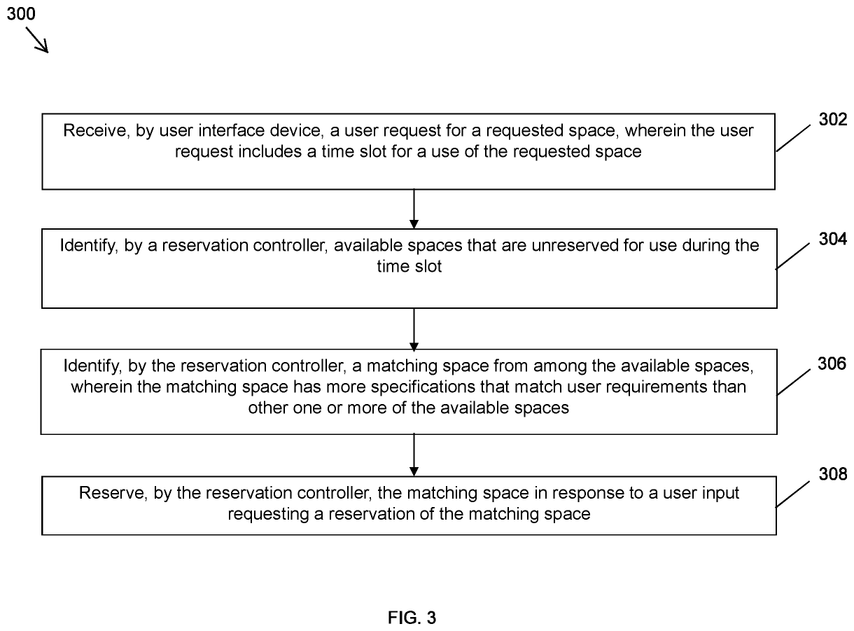

FIG. 3 illustrates a method 300 of reserving a space based on a time slot according to another example embodiment. Referring to FIGS. 1 and 3, at step 302, the method 300 may include receiving, by the user interface device 102, a user request for a requested space. For example, the user request may include a time slot for a use of the requested space. At step 304, the method 300 may include identifying, by the reservation controller 104, available spaces that are unreserved for use during the time slot. For example, the reservation controller 104 may receive the user request from the user interface device 102.

In some example embodiments, at step 306, the method 300 may include identifying, by the reservation controller 104, a matching space from among the available spaces. For example, the matching space may have more specifications that match more user requirements than other/remaining one or more of the available spaces. At step 306, the method 300 may include reserving, by the reservation controller 104, the matching space in response to a user input requesting a reservation of the matching space.

In some alternative embodiments, the steps of the method 300 may be performed in a different order than described above without departing from the scope of this disclosure. In some alternative embodiments, the method 300 may include more steps than described above without departing from the scope of this disclosure. For example, one or more steps of the method 300 may be combined with one or more steps of the other methods described herein.

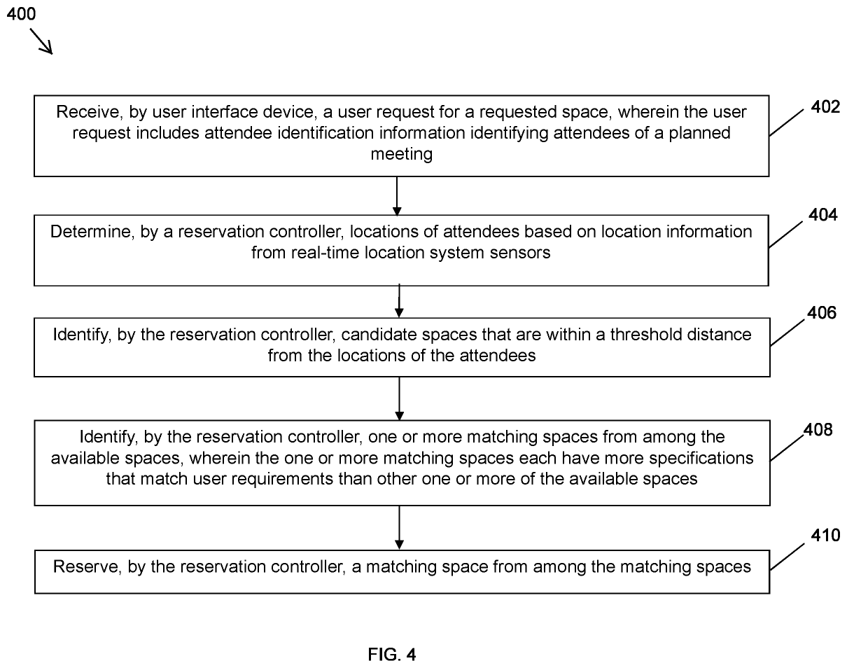

FIG. 4 illustrates a method 400 of reserving a space based on locations of attendees according to an example embodiment. Referring to FIGS. 1 and 4, at step 402, the method 400 may include receiving, by the user interface device 102, a user request for a requested space. For example, the user request may include attendee identification information identifying attendees of a planned meeting. At step 404, the method 400 may include determining, by the reservation controller 104, locations of attendees based on location information from real-time location system sensors. As described above with respect to FIG. 1, sensors, such as the sensor 146, may receive beacon signals from RTLS devices (e.g., devices 140, 142) of attendees and provide location information to the reservation controller 104.

In some example embodiments, at step 406, the method 400 may include identifying, by the reservation controller 104, candidate spaces that are within a threshold distance (e.g., 30 yards) from the locations of the attendees. At step 408, the method 400 may include identifying, by the reservation controller 104, one or more matching spaces from among the available spaces. For example, the one or more matching spaces may each have more specifications that match user requirements (e.g., room size or capacity, required or desired fixed equipment, required or desired portable equipment, etc.) than other/remaining one or more of the available spaces. At step 410, the method 400 may include reserving, by the reservation controller 104, a matching space from among the matching spaces. For example, the reservation controller 104 may identify/select the match space based on a user input provided to the user interface device 102.

In some alternative embodiments, the steps of the method 400 may be performed in a different order than described above without departing from the scope of this disclosure. In some alternative embodiments, the method 400 may include more steps than described above without departing from the scope of this disclosure. For example, one or more steps of the method 400 may be combined with one or more steps of the other methods described herein.

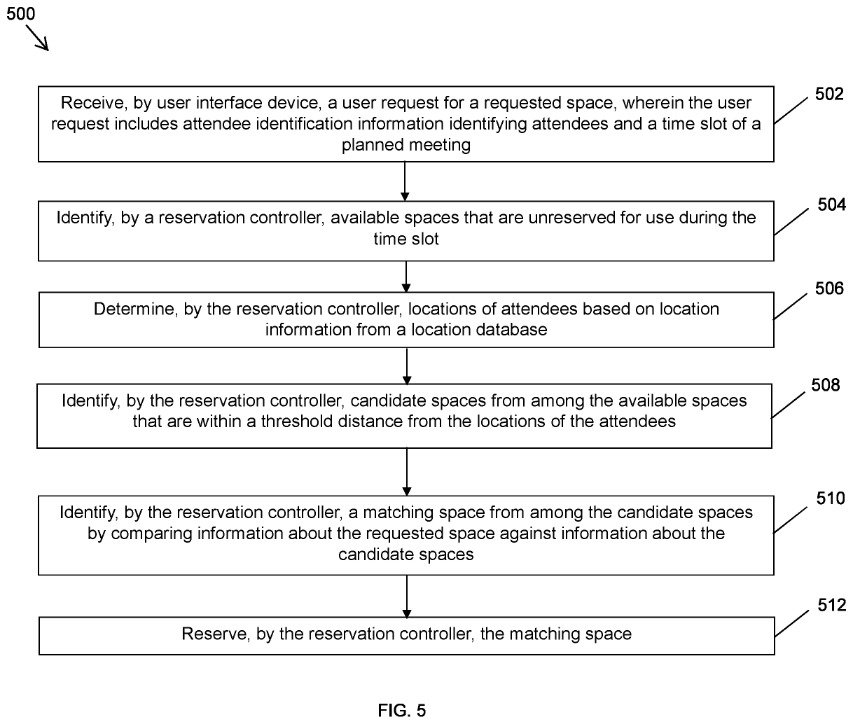

FIG. 5 illustrates a method 500 of reserving a space based on locations of attendees according to another example embodiment. Referring to FIGS. 1 and 5, in some example embodiments, the method 500 includes, at step 502, receiving, by the user interface device 102, a user request for a requested space. For example, the user request may include attendee identification information identifying attendees and a time slot of a meeting. At step 504, the method 500 may include identifying, by the reservation controller 104, available spaces that are unreserved for use during the time slot, for example, based on information in a reservation database.

In some example embodiments, at step 506, the method 500 may include determining, by the reservation controller 104, locations of attendees (e.g., the individuals 136, 138, etc.). For example, the reservation controller 104 may determine locations of attendees based on location information from a location database. For example, the location database may be or may include a database of employee office locations. At step 508, the method 500 may include identifying, by the reservation controller 104, candidate spaces from among the available spaces that are within a threshold distance (e.g., 50 feet, same building, etc.) from the locations of the attendees.

In some example embodiments, at step 510, the method 500 may include identifying, by the reservation controller 104, a matching space from among the candidate spaces by comparing information about the requested space (i.e., user requirements) against information about the candidate spaces (specifications of spaces such a capacity, location, fixed equipment, portable equipment, etc.). At step 512, the method 500 may include reserving, by the reservation controller 104, the matching space. For example, the reservation controller 104 may reserve the matching space upon identifying the matching space or in response to a user input selecting the matching space after the matching space is indicated to the user.

In some alternative embodiments, the steps of the method 500 may be performed in a different order than described above without departing from the scope of this disclosure. In some alternative embodiments, the method 500 may include more steps than described above without departing from the scope of this disclosure. For example, one or more steps of the method 500 may be combined with one or more steps of the other methods described herein.

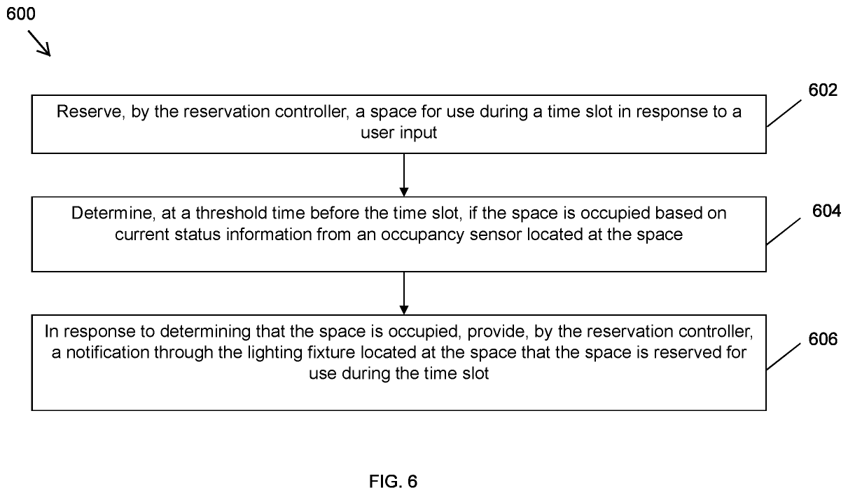

FIG. 6 illustrates a method 600 of space reserving and notification according to an example embodiment. Referring to FIGS. 1 and 6, in some example embodiments, the method 600 includes, at step 602, reserving, by the reservation controller 104, in response to a user input, a space (e.g., the space 108 or 112) for use during a time slot. For example, the methods 200-500 may be used to reserve the space. At step 604, the method 600 may include determining, by the reservation controller 104, at a threshold time (e.g., 3 minutes) before the time slot, if the space is occupied. For example, the reservation controller 104 may determine if the space is occupied based on current status information from one or more occupancy sensors located at the space.

In some example embodiments, at step 606, the method 600 may include, in response to determining that the space is occupied, providing, by the reservation controller 104, a notification through the lighting fixture located at the space that the space is reserved. For example, the notification may be flashing a light provided by the lighting fixture, etc. To illustrate, a person occupying the space may interpret the notification as indicating that the space is reserved for use during a time slot that starts right after the threshold time. For example, if the person is not a participant in the upcoming meeting, the person may leave the space.

In some alternative embodiments, the method 600 may include more steps than described above without departing from the scope of this disclosure. To illustrate, one or more steps of the method 600 may be combined with one or more steps of one or more methods 2-5 and 7.

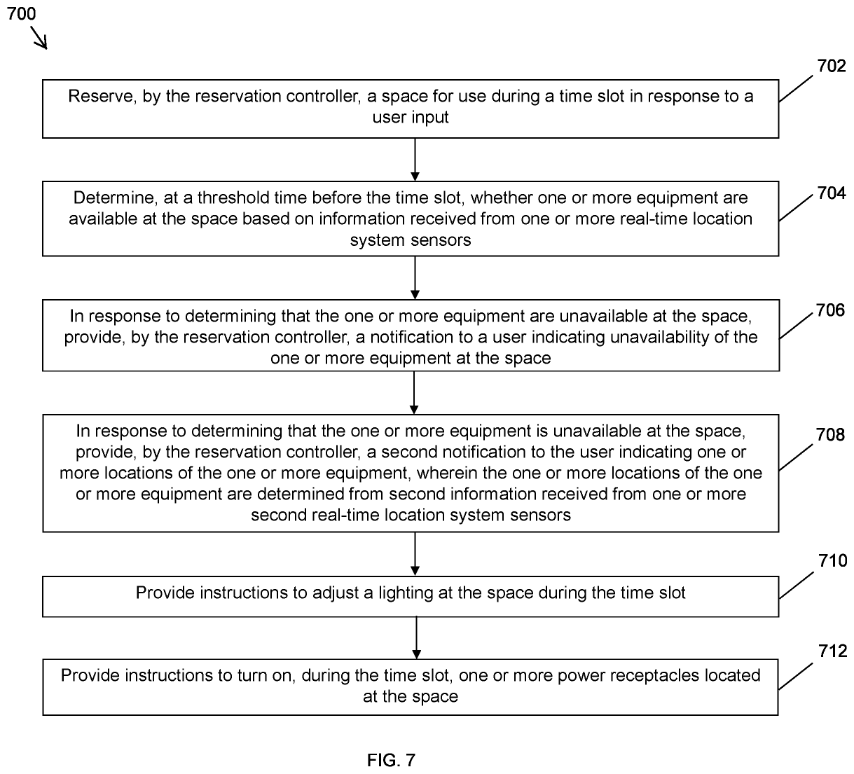

FIG. 7 illustrates a method 700 of space reserving and space preparation according to an example embodiment. Referring to FIGS. 1 and 7, in some example embodiments, the method 700 includes, at step 702, reserving, by the reservation controller 104, a space for use during a time slot in response to a user input. For example, the methods 200-500 may be used to reserve the space. At step 704, the method 700 may include determining, by the reservation controller 104, whether one or more pieces of equipment are available at the space (e.g., the space 112) based on information received from one or more real-time location system sensors (e.g., the sensor 134). For example, the reservation controller 104 may determine whether the one or more pieces of equipment are available at the space at a threshold time (e.g., 3 minutes) before the time slot. The reservation controller 104 may poll the one or more real-time location system sensors (e.g., the sensor 134) to determine whether a piece of equipment is in the space.

In some example embodiments, at step 706, the method 700 may include, in response to determining that the one or more pieces of equipment is unavailable at the space, providing, by the reservation controller 104, a notification to a user indicating unavailability of the one or more pieces of equipment at the space. For example, the reservation controller 104 may send one or more of an email notification, a text message, etc. to the user (e.g., the person that requested the reservation). At step 708, the method 700 may include, in response to determining that the one or more pieces of equipment is unavailable at the space, providing, by the reservation controller 104, a second notification to the user indicating one or more locations of the one or more equipment. For example, the one or more locations of the one or more pieces of equipment may be determined from information received from one or more second real-time location system sensors.

In some example embodiments, at step 710, the method 700 may include providing instructions to adjust a lighting at the space during the time slot. For example, the reservation controller 104 or the lighting controller 106 may provide lighting control instructions to one or more lighting fixtures in the space. At step 710, the method 700 may include providing instructions to turn on, during the time slot, one or more power receptacles located at the space. For example, a power receptacle at the space may be used to provide power to a projector.

In some example embodiments, the wayfinding guide may be provided to the user and/or other attendees by sending route information relative to current locations of the user and/or other attendees as determined by RTLS sensors until the user and/or attendees reach the matched/reserved location. For example, the wayfinding guide may be provided to the user's or attendees' mobile devices.

In some example embodiments, one or more steps of the methods described above may be omitted or performed in a different order than described. In some example embodiments, the methods may include other steps. In some example embodiments, some of the steps of the different methods of FIGS. 2-7 may be combined without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A non-transitory computer-readable medium of a reservation controller, wherein the non-transitory computer-readable medium contains instructions executable by a processor, the instructions comprising:
receiving a user request for a requested space, wherein the user request includes a time slot for a use of the requested space;
identifying unoccupied spaces based on current status information from multiple occupancy sensors in response to determining that the time slot is within a threshold period of time from a current time, wherein the unoccupied spaces are one or more of multiple spaces that are currently unoccupied;
identifying available spaces from among the unoccupied spaces; and
reserving a matching space from among the available spaces.

2. The non-transitory computer-readable medium of claim 1, wherein the instructions comprise identifying, by the reservation controller, one or more matching spaces from among the available spaces, wherein the one or more matching spaces each have a greater number of specifications that match user requirements than remaining one or more of the available spaces, and wherein the matching space is identified from among the one or more matching spaces.

3. The non-transitory computer-readable medium of claim 2, wherein the instructions comprise displaying, by a user interface device, identification information identifying the one or more matching spaces.

4. The non-transitory computer-readable medium of claim 1, wherein one or more occupancy sensors of the multiple occupancy sensors are integrated in lighting fixtures located at one or more spaces of the multiple spaces.

5. The non-transitory computer-readable medium of claim 1, wherein one or more occupancy sensors of the multiple occupancy sensors are standalone occupancy sensors located at one or more spaces of the multiple spaces.

6. The non-transitory computer-readable medium of claim 1, wherein the available spaces are unreserved for use during the time slot.

7. The non-transitory computer-readable medium of claim 1, further comprising controlling a lighting of the matching space at a start of the time slot.

8. A non-transitory computer-readable medium of a reservation controller, wherein the non-transitory computer-readable medium contains instructions executable by a processor, the instructions comprising:
reserving a space for use during a time slot;
determining, at a threshold time before the time slot, if the space is occupied based on current status information received from an occupancy sensor located at the space; and
in response to determining that the space is occupied, providing a notification through a lighting fixture located at the space that the space is reserved.

9. The non-transitory computer-readable medium of claim 8, wherein the instructions further comprise reserving the space in response to a user input.

10. The non-transitory computer-readable medium of claim 8, wherein the instructions further comprise determining whether one or more pieces of equipment are available at the space based on information received from one or more real-time location system sensors.

11. The non-transitory computer-readable medium of claim 10, wherein the instructions further comprise, in response to determining that the one or more pieces of equipment are unavailable at the space, providing a second notification to a user indicating unavailability of the one or more pieces of equipment at the space.

12. The non-transitory computer-readable medium of claim 10, wherein the instructions further comprise, in response to determining that the one or more pieces of equipment are unavailable at the space, providing a second notification to the user indicating one or more locations of the one or more pieces of equipment and wherein the one or more locations of the one or more pieces of equipment are determined from second information received from one or more second real-time location system sensors.

13. The non-transitory computer-readable medium of claim 8, wherein the instructions further comprise controlling a lighting fixture located at the space to adjust a light provided by the lighting fixture at a start of the time slot.

14. The non-transitory computer-readable medium of claim 13, wherein controlling the lighting fixture comprises providing one or more instructions to change a dim level or a color temperature of the light.

15. The non-transitory computer-readable medium of claim 8, wherein the instructions further comprise controlling a power receptacle located at the space to provide power during the time slot.

16. A system of reservation and notification, comprising:
a reservation controller configured to reserve a space for a time slot;
a lighting fixture located at the space; and
an occupancy sensor located at the space, wherein the reservation controller is configured to determine, at a threshold time before the time slot, if the space is occupied based on current status information received from an occupancy sensor located at the space and to provide, in response to determining that the space is occupied, a notification through the lighting fixture that the space is reserved.

17. The system of claim 16, wherein the reservation controller is configured to control the lighting fixture to adjust a light provided by the lighting fixture at a start of the time slot.

18. The system of claim 16, wherein the occupancy sensor is integrated in the lighting fixture located at the space.

19. The system of claim 16, wherein the reservation controller is configured to determine whether one or more pieces of equipment are available at the space based on information received from one or more real-time location system sensors.

20. The system of claim 16, wherein the reservation controller is configured to provide, in response to determining that the one or more pieces of equipment are unavailable at the space, a second notification to a user indicating unavailability of the one or more pieces of equipment at the space.
